(19) United States
(12) Patent Application Publication
(10) Pub. No.: US 2010/0245780 A1
(43) Pub. Date: Sep. 30, 2010

(54) PROJECTION DISPLAY APPARATUS

(75) Inventors: Takaaki ABE, Osaka (JP); Masutaka Inoue, Osaka (JP); Susumu Tanase, Osaka (JP); Yoshinao Hiranuma, Osaka (JP); Tomoya Terauchi, Osaka (JP); Masahiro Haraguchi, Osaka (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD, Moriguchi-shi (JP)

(21) Appl. No.: 12/716,428

(22) Filed: Mar. 3, 2010

(30) Foreign Application Priority Data
Mar. 24, 2009 (JP) 2009-072821

(51) Int. Cl. G03B 21/14

(52) U.S. Cl. 353/85; 353/122

(57) ABSTRACT

A detection unit detects an entering object that will enter at least a projection space. When an entering object has been detected by a first detection unit, a controller initiates safety processing, the safety processing being milder than safety processing that is initiated when an error has occurred in the projection display apparatus itself. For example, when an entering object has been detected, the controller controls components of the projection display apparatus so as to switch to the projection of a black image and so as to maintain the state of the projection display apparatus, excluding the switching.

### CROSS-REFERENCE TO RELATED APPLICATIONS

This application is based upon and claims the benefit of priority from the prior Japanese Patent Applications No. 2009-072821, filed Mar. 24, 2009, the entire contents of which are incorporated herein by reference.

### BACKGROUND OF THE INVENTION

1. Field of the Invention

The present invention relates to a projection display apparatus for projecting an image on a projection plane.

2. Description of the Related Art

Recently, the development of projectors in which lasers with large radiation energy are used as light sources has been under way. It is necessary to take sufficient measures for a person not to erroneously enter a projection space through which the light projected from such a projector passes. Accordingly, a technique in which an entering object is detected by providing a sensor for detecting an infrared ray from the screen direction has been proposed.

If a failure occurs in an internal component of a projector, such as a light source, it is common to implement safety processing in which operations of the major components including a light modulator such as a DMD (Digital Micro-mirror Device), a cooling mechanism, or the like, are stopped. It is because the failure is suppressed from spreading to other components or subsequent repair work can be performed smoothly.

On the other hand, if the aforementioned entering object is detected, it is necessary to implement certain safety processing. However, being different from the aforementioned failure occurring in a projector itself, it is preferable that a projector is restored to the normal processing immediately after the entering object has been out of the monitored area. If the aforementioned safety processing, implemented when a failure has occurred in a projector itself, is applied to the case where an entering object is detected, it becomes necessary to restart a cooling mechanism, etc., when the projector is restored to the normal processing, thereby taking a certain amount of time until the projector is restored to the normal processing. This time makes a viewer who is watching a projected image feel a stress.

### SUMMARY OF THE INVENTION

A projection display apparatus of an embodiment of the present invention is used for projecting an image on a projection plane. The projection display apparatus comprises: a detection unit configured to detect an entering object that will enter at least a projection space; and a controller configured to initiate safety processing when an entering object is detected by the detection unit, the safety processing being milder than safety processing that is initiated when an error has occurred in the projection display apparatus itself.

It is noted that any combination of the aforementioned components or any manifestation of the present invention exchanged between methods, apparatuses, systems and so forth, is effective as an embodiment of the present invention.

### BRIEF DESCRIPTION OF THE DRAWINGS

Embodiments will now be described, byway of example only, with reference to the accompanying drawings which are meant to be exemplary, not limiting, and wherein like elements are numbered alike in several Figures, in which:

FIGS. 1A and 1B are views illustrating an installation example of a short throw distance type projection display apparatus;

FIG. 2 is a view schematically illustrating the side cross section of the projection display apparatus illustrated in FIGS. 1A and 1B;

FIG. 3 is a view illustrating a structure example of the optical system of the projection display apparatus illustrated in FIGS. 1A and 1B;

FIG. 4 is a view illustrating an example in which a first detection unit is installed on the casing of the projection display apparatus illustrated in FIGS. 1A and 1B;

FIG. 5 is a block diagram illustrating the structure of a projection display apparatus according to an embodiment of the present invention;

FIG. 6 is a flow chart illustrating the whole operations of the projection display apparatus according to the embodiment;

FIG. 7 is a flow chart illustrating an example of the normal end processing;

FIG. 8 is a flow chart illustrating a first example of safety processing for detecting an entering object;

FIG. 9 is a flow chart illustrating a second example of the safety processing for detecting an entering object;

FIG. 10 is a view illustrating a light source unit in which a plurality of light sources are arrayed;

FIG. 11 is a flow chart illustrating a first example of safety processing for detecting an internal error; and

FIG. 12 is a flow chart illustrating a second example of the safety processing for detecting an internal error.

### DETAILED DESCRIPTION OF THE INVENTION

The invention will now be described by reference to the preferred embodiments. This does not intend to limit the scope of the present invention, but to exemplify the invention.

The preferred embodiments of the present invention will now be described by reference to a short throw distance type projection display apparatus. The present invention should not be limited to a short throw distance type projection display apparatus but is applicable to any projection display apparatus, such as a front-projection display apparatus, a laser-scanning projection display apparatus, and the like.

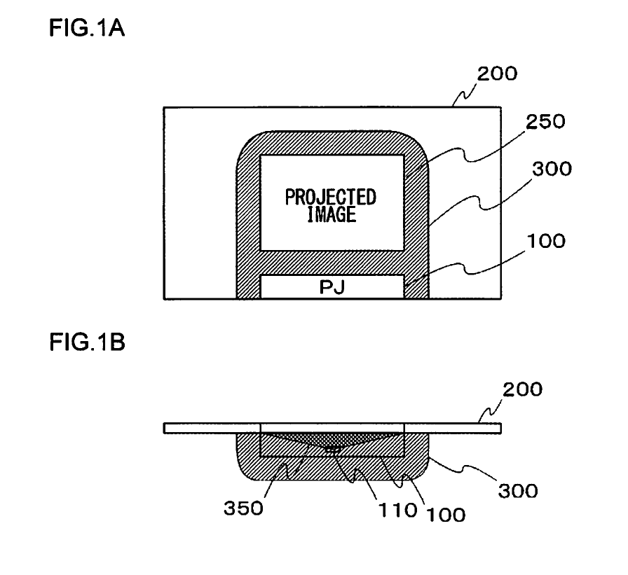

FIGS. 1A and 1B are views illustrating an installation example of a short throw distance type projection display 100. FIG. 1A is a view illustrating a projection plane 200 and the projection display 100, when seen from the front, whereas FIG. 1B is a view illustrating both, when seen from the top.

The casing of the projection display 100 illustrated in FIGS. 1A and 1B is structured to have a rectangular parallelepiped shape whose width is greater than the height or the depth thereof. FIGS. 1A and 1B illustrate an example in which the projection plane 200, such as a screen and a wall, etc., is in contact with the floor surface. The projection display 100 (which is denoted with PJ in FIG. 1A) is installed on the floor surface, and installed at the position where the front of the casing is substantially in contact with the projection plane 200. In the projection plane 200, a projection area 250 is formed, on which a projected image projected from the projection display 100 is to be projected. A projection port 110 is provided on the upper surface of the casing of the projection display 100, and the light emitted from the projection port 110 is guided to the projection area 250.

The area of FIGS. 1A and 1B, drawn with diagonal lines, illustrates a detection area (which may also be considered as a monitored area) 300 in which an entering object is to be detected. Herein, the detection area 300 is set to an area including both the range between the projection space 350, through which the light emitted from the projection port 110 passes, the range within a certain distance (e.g., 1.0 m) from the projection space 350, and the range within a certain distance (e.g., 1.0 m) from the main body of the projection display 100.

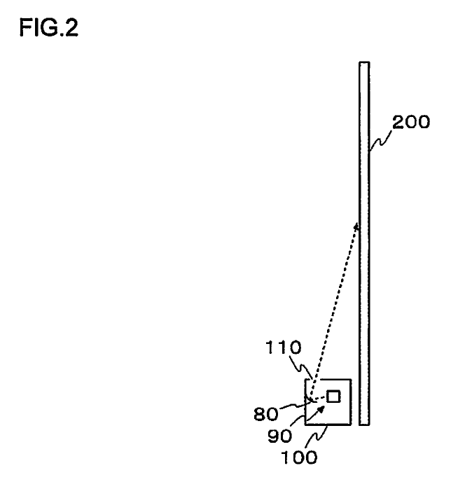

FIG. 2 is a view schematically illustrating the side cross section of the projection display 100 illustrated in FIGS. 1A and 1B. The optical system 90, provided in the projection display 100, includes a reflective mirror 80 by which the light emitted from a projection lens, which will be described later, is reflected to be guided onto the projection plane 200 through the projection port 110.

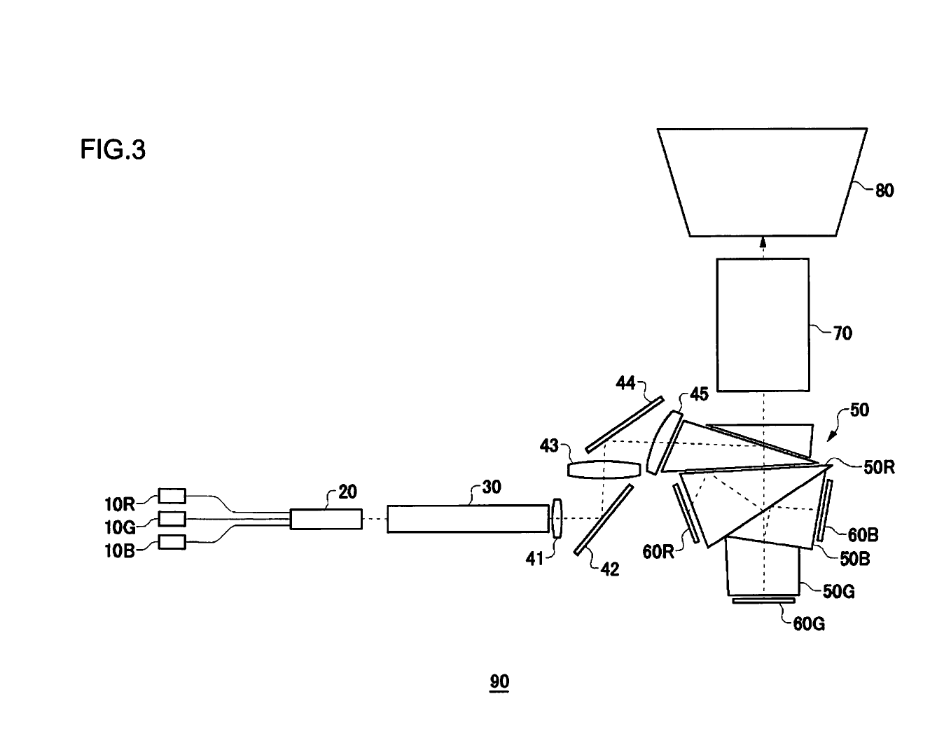

FIG. 3 is a view illustrating a structure example of the optical system 90 of the projection display 100 illustrated in FIGS. 1A and 13. In this structure example, three primary color laser light sources (a red light source 10R, a green light source 10G, and a blue light source 10B) are provided. A plurality of the red light sources 10R, the green light source 10G, or the blue light sources 10B, may be provided. Each light source is connected to an optical fiber. The optical fibers, connected to each light source, are bundled with a fiber bundle 20, and the light emitted from the end of each optical fiber is incident on a color separation/synthesis prism 50 through a rod integrator 30, a first relay lens 41, a first mirror 42, a second relay lens 43, a second mirror 44, and a third relay lens 45.

The light that has been incident on the color separation/synthesis prism 50 is separated into a red light, a green light, and a blue light, by a red prism 50R, a green prism 50G, and a blue prism 50B, of which the color separation/synthesis prism 50 is composed. The red light, the green light, and the blue light thus separated are incident on a reflective-type red light modulator 60R, green light modulator 60G, and blue light modulator 60B, respectively. For example, a DMD (Digital Micro-mirror apparatus) can be used in the red light modulator 60R, the green light modulator 60G, or the blue light modulator 60B. The red light modulator 60R, the green light modulator 60G, and the blue light modulator 60B respectively modulate the incident red light, green light, and blue light in accordance with an image signal of each color, the image signal being set by an image signal setting unit 65, which will be described later.

The light paths of the red light, the green light, and the blue light, which have been modulated by the red light modulator 60R, the green light modulator 60G, and the blue light modulator 60B, respectively, are integrated by the red prism 50R, the green prism 50G, and the blue prism 50B so that the light, synthesized with each light, is incident on a projection lens 70 from the color separation/synthesis prism 50.

The projection lens 70 widens the angle of the light, incident from the color separation/synthesis prism 50, to emit the light on the reflective mirror 80. The reflective mirror 80 further widens the angle of the light, incident from the projection lens 70, to guide the light to the projection plane 200 from the projection port 110 (see FIG. 2). An aspheric mirror may be used for the reflective mirror 80. The projection lens 70 and the reflective mirror 80 may be composed of an integrated hybrid projection optical system.

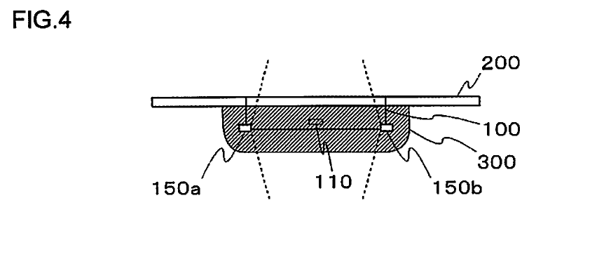

FIG. 4 is a view illustrating an example in which a first detection unit 150 is installed on the casing of the projection display 100 illustrated in FIGS. 1A and 1B. The first detection unit 150 for detecting an entering object that will enter at least the projection space 350 (see FIG. 1B) is provided on the upper surface of the casing of the projection display 100. The first detection unit 150 may be: a camera for capturing an entering object; an infrared sensor for detecting the infrared ray reflected by an entering object; or an infrared camera for detecting the infrared ray emitting from an entering object. Herein, an example is illustrated in which two cameras (a first camera 150a and a second camera 150b) are installed. Dashed lines in FIG. 4 indicate the fields of view of the first camera 150a and the second camera 150b.

The first camera 150a and the second camera 150b are installed on both side edges of the casing of the projection display 100 so as to face each other. More specifically, the first camera 150a is installed in the upper left corner on the back side of the casing whereas the second camera 150b is installed in the upper right corner on the back side of the casing. Thereby, a larger area of the projected image, projected on the projection plane 200, can be included within the fields of view of both cameras.

In the arrangement example illustrated in FIG. 4, at least the right half of the aforementioned projected image, the right side direction of the casing, and at least the right half of the back direction of the casing are included within the field of view of the first camera 150a. At least the left half of the aforementioned projected image, the left side direction of the casing, and at least the left half of the back direction of the casing are included within the field of view of the second camera 150b. When combining the images captured by the first camera 150a and the second camera 150b, the whole of the aforementioned projected image can be included within the fields of view of both cameras.

Accordingly, even an object that has entered the side direction or the back direction of the casing can be captured by the first camera 150a and the second camera 150b in addition to that an object that has entered the projected image, projected on the projection plane 200, and the projection space 350 and its vicinity, can be captured by both cameras. That is, any object that will enter the detection area 300 can be captured.

The number and the arrangement of the first detection units 150 illustrated in FIG. 4 are merely an example, and therefore the number and the arrangement should not be limited thereto.

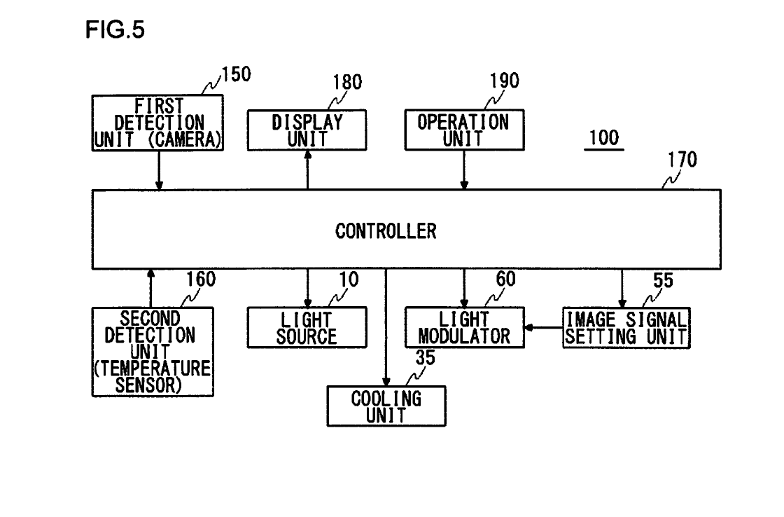

FIG. 5 is a block diagram illustrating the structure of a projection display 100 according to an embodiment of the present invention. The projection display 100 comprises a light source 10, an image signal setting unit 55, a light modulator 60, a cooling unit 35, a first detection unit 150, a second detection unit 160, a controller 170, a display unit 180, and an operation unit 190.

The first detection unit 150 is used for detecting an entering object that will enter at least the projection space 350. When the first camera 150a and the second camera 150b are installed, as stated above, each of the first camera 150a and the second camera 150b converts the incident light into an electrical signal to supply to the controller 170.

The image signal setting unit 55 separates the image signal, which is inputted from a non-illustrated image signal holder, into image signals of each color (for example, an image signal for red color, an image signal for green color, and an image signal for blue color) such that the image signals of each color are set in the red light modulator 60R, the green light modulator 60G, and the blue light modulator 60B, respectively.

The cooling unit 35 is provided in order to maintain the temperature in the casing of the projection display 100 (in particular, the temperatures near the light source 10 and the light modulator 60) within a predetermined temperature range. The cooling unit 35 may be a chiller mechanism or a fan mechanism. The cooling unit 35 maintains the temperature in the casing at a temperature less than or equal to the aforementioned threshold value temperature mainly by suppressing increases in the temperatures of the light source 10 and the light modulator 60.

The second detection unit 160 is used for detecting an error occurring in the projection display 100 itself. In the present embodiment, a state is assumed as the error in which the temperature in the casing exceeds the upper limit threshold value of the aforementioned temperature range. It can be thought that the state occurs mainly because the intensity of the light emitted from the light source 10 is too strong, or because the cooling capability of the cooling unit 35 is too low. That is, the state occurs mainly due to a failure in the light source 10 or in the cooling unit 35.

The second detection unit 160 may be a temperature sensor. The temperature sensor is installed in the vicinity of at least one of the light source 10 and the light modulator 60. The temperature sensor supplies the detected temperature to the controller 170. Alternatively, an illuminance sensor for detecting the intensity of the light emitted from the light source 10 may be installed in the vicinity of the light source 10, as the second detection unit 160. The illuminance sensor can be installed alternatively with the aforementioned temperature sensor or additionally thereto.

A failure in the light source 10 can be detected by detecting a change in the temperature of the light source 10 or in the illuminance thereof. If the temperature or the illuminance of the light source 10 changes rapidly, it can be estimated that the light source 10 has broken down.

Either when an entering object is detected by the first detection unit 150, or when the aforementioned error is detected by the second detection unit 160, the controller 170 initiates safety processing. When an entering object is detected, the controller 170 initiates the safety processing, the safety processing being milder than the safety processing that is initiated when the aforementioned error is detected. In the milder safety processing, the restore processing can be performed easily in comparison with the safety processing that is initiated when the error is detected. The milder safety processing substantially stops the operations of minimum components among a plurality of components mounted on the projection display 100, so that the operations of as many components as possible are maintained. The specific contents of the safety processing will be described later.

The display unit 180 and the operation unit 190 are user interfaces. Both may be composed of touch panel displays or of combinations of display panel with operation buttons. The display unit 180 displays a current status or a message. Upon receiving a user's direction, the operation unit 190 converts the user's direction into a control signal to supply to the controller 170.

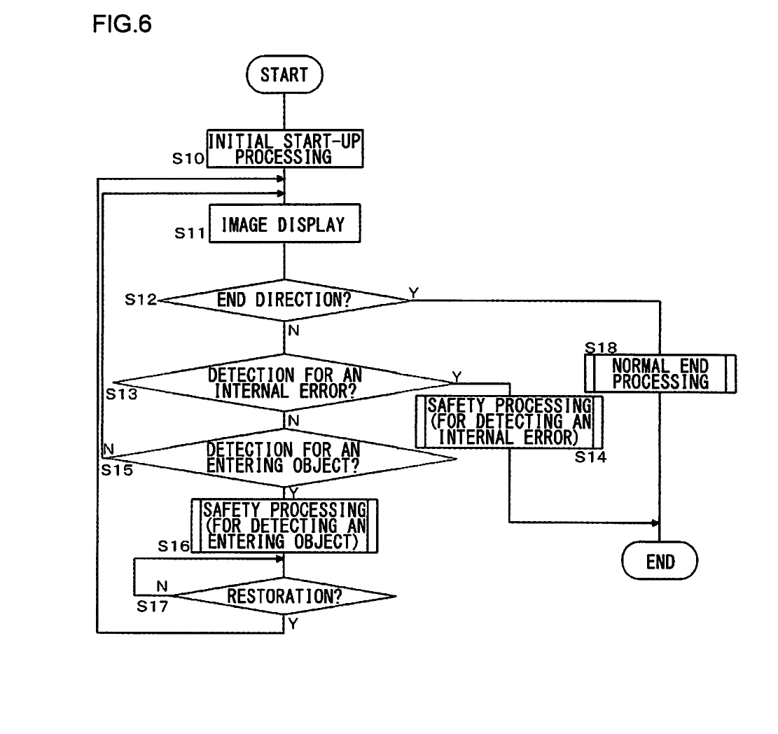

FIG. 6 is a flow chart illustrating the whole operations of the projection display 100 according to the embodiment. Herein, a failure of the light source 10 will be taken as an example of an internal error to be detected by the second detection unit 160.

When a power supply is at first switched on by a user, the controller 170 executes the initial start-up processing (S10). For example, the controller 170 executes calibrations of the light source 10, the cooling unit 35, and the light modulator 60. When a predetermined image file is directed to be projected by a user, the controller 170 controls each component such that the image signal, included in the image file, is displayed on the projection plane 200 as an image (S11).

When the operation unit 190 receives an end direction from the user (S12/Y), the controller 170 initiates the normal end processing (S18). Specific contents of the normal end processing will be described later. While the operation unit 190 does not receive the end direction from the user (S12/N), the controller 170 determines whether an internal error has occurred with reference to the signal from the second detection unit 160 (S13). When an internal error has occurred (S13/Y), the controller 170 initiates the safety processing for detecting an internal error (S14). Specific contents of the safety processing will be descried later. When an internal error has not occurred (S13/N), the controller 170 does not initiate the safety processing.

While the operation unit 190 does not receive the end directions from the user (S12/N), the controller 170 determines whether the internal error has occurred, and also determines whether an entering object is present in the detection area by analyzing the signal supplied from the first detection unit 150 (S15). When an entering object is detected (S15/Y), the controller 170 initiates the safety processing for detecting an entering object (S16). Specific contents of the safety processing will be described later. When an entering object is not detected (S15/N), the safety processing is not initiated.

After initiating the safety processing for detecting an entering object, the controller 170 determines whether the state can be restored (S17). In the case where the state can be restored (S17/Y), relevant component is restored, subsequently returning to the normal image display processing (S11). Herein, the case where the state can be restored means the state in which an entering object is no longer detected in the aforementioned detection area. After being in the state, the controller 170 may automatically restore the relevant component to the normal image display processing or may restore the component after receiving a reproduction direction from the user. In the case where the state cannot be restored (S17/N), the controller 170 waits until the state can be restored.

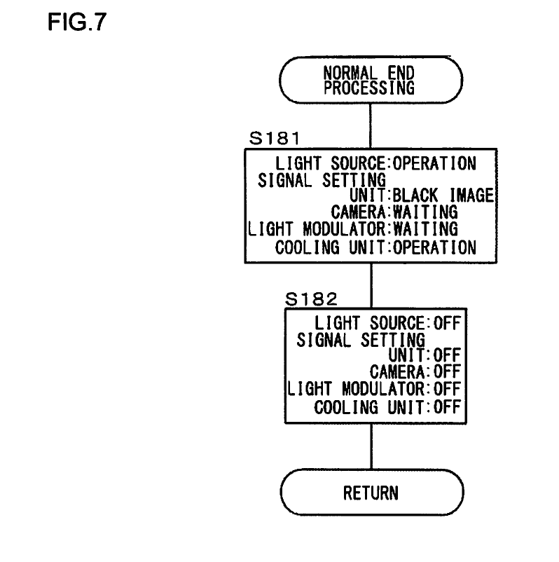

FIG. 7 is a flow chart illustrating an example of the normal end processing (S18). The controller 170 controls, as the first step, the image signal setting unit 55 such that a black image is set in the light modulator 60 (S181), while operating the light source 10 and the cooling unit 35 in the current state, and while making transitions of the first detection unit 150 (the first camera 150a and the second camera 150b) and of the light modulator 60 to waiting states. Herein, the black image may be an image in which pixel values of all the pixels are substantially zero.

As the second step, the controller 170 makes transitions of all of the light source 10, the cooling unit 35, the first detection unit 150, the light modulator 60, and the image signal setting unit 55 to off states (S182). By switching off the components of the image signal system in a stepwise manner, the situation in which a failure occurs in a circuit or the image signal at the previous start-up still remains at the next start-up can be suppressed from occurring.

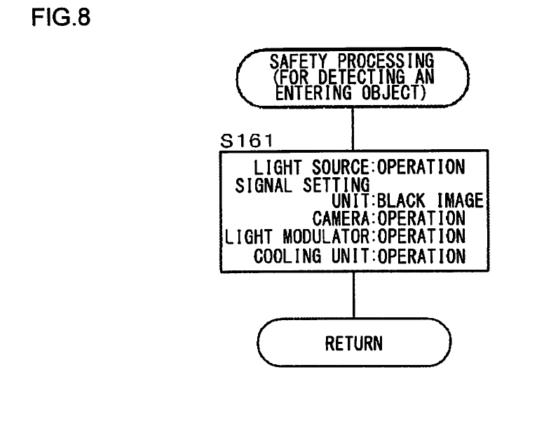

FIG. 8 is a flow chart illustrating a first example of the aforementioned safety processing for detecting an entering object (S16). When an entering object is detected, the controller 170 controls the image signal setting unit so as to switch to the projection of a black image, and also controls relevant components so as to maintain the state of the projection display 100 (more specifically, the operating state thereof), excluding the aforementioned switching. More specifically, the controller 170 controls the image signal setting unit 55 so as to set a black image in the light modulator 60 (S161), while operating the light source 10, the first detection unit 150, the light modulator 60, and the cooling unit 35.

Thereby, the restore processing can be simplified. That is, it is sufficient that the image signal to be set in the light modulator 60 by the image signal setting unit 55 is returned to the image signal, displayed at the detection of an entering object, from the black image. Because the failure has not occurred in a component itself of the projection display 100, there is no necessity for stopping the operations of the components.

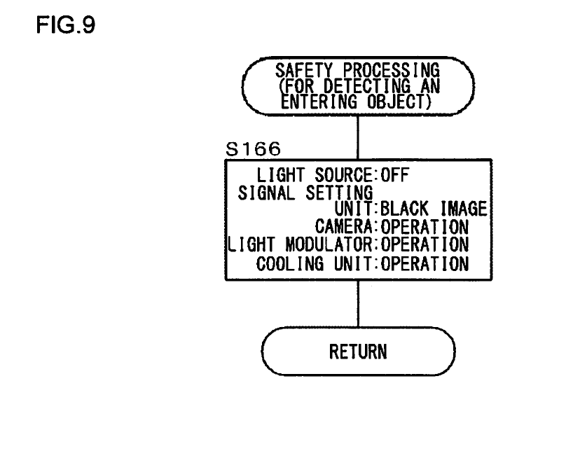

FIG. 9 is a flow chart illustrating a second example of the aforementioned safety processing for detecting an entering object (S16). When an entering object is detected, the controller 170 controls relevant components so as to stop the operation of the light source 10, and so as to maintain the state of the projection display 100, excluding the aforementioned stop. More specifically, the controller 170 controls relevant components so as to make a transition of the light source 10 to an off state (S166), while operating the first detection unit 150, the light modulator 60, and the cooling unit 35. The image to be set in the light modulator 60 by the image signal setting unit 55 may be a black image or the image displayed at the detection of the entering object.

Thereby, the restore processing can be simplified, and safety can be further enhanced by stopping the emission of light from the light source 10.

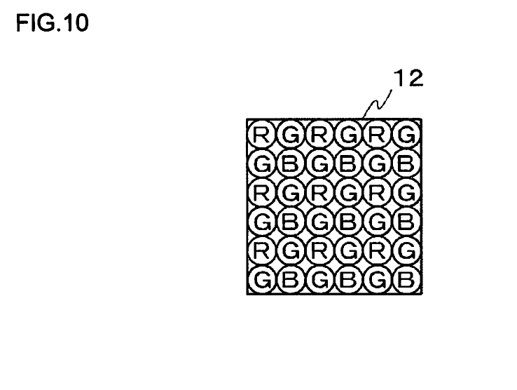

FIG. 10 is view illustrating a light source unit 12 in which a plurality of light sources 10 are arrayed. A projection display 100 in which a plurality of laser light sources of each color (R, G, B) are mounted in order to emit a laser light with a large intensity has been developed. In this case, in the flow chart illustrating the second example of the aforementioned safety processing for detecting an entering object (S16), illustrated in FIG. 9, the controller 170 controls, in the step S166, relevant components so as to stop the operations of the plurality of light sources 10 in a stepwise manner. The processing other than that are the same as those in the flow chart in FIG. 9.

As stated above, by switching off a plurality of light sources 10 in a stepwise manner (for example, one light source per second), a rapid change in the temperature near the light source unit 12 can be suppressed. Accordingly, it can also be suppressed that the light source unit 12 is cooled excessively by the cooling unit 35 while waiting for the restore.

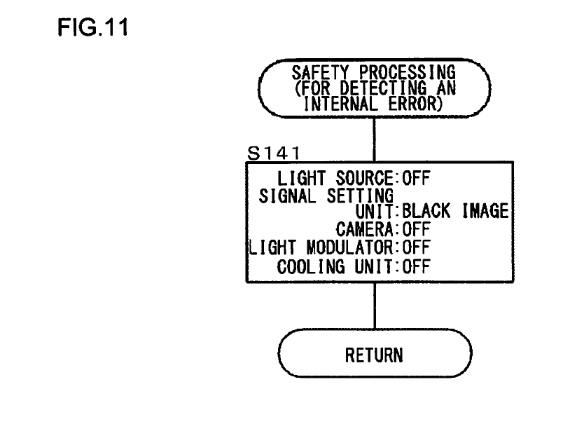

FIG. 11 is a flow chart illustrating a first example of the aforementioned safety processing for detecting an internal error (S14). The controller 170 controls relevant components so as to make transitions of the light source 10, the first detection unit 150, the light modulator 60, and the cooling unit 35 to off states (S141). The image to be set in the light modulator 60 by the image signal setting unit 55 may be a black image or the image displayed at the detection of the entering object.

As stated above, when an internal error has occurred, the possibility that the component in which the failure has occurred may adversely affect other components can be reduced by switching off all of the major components as soon as possible, different from the normal end processing.

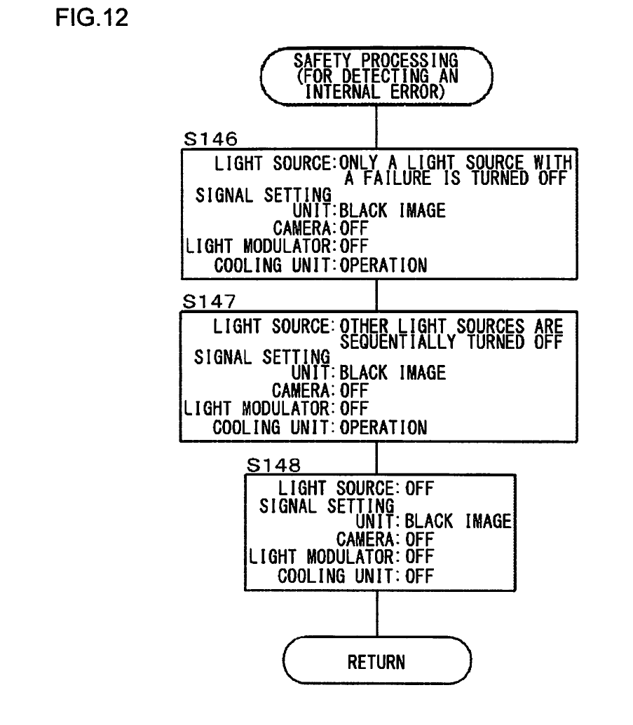

FIG. 12 is a flow chart illustrating a second example of the aforementioned safety processing for detecting an internal error (S14). In the second example, it is assumed that a plurality of light sources 10 are installed, as illustrated in FIG. 10. In addition, it is assumed that the temperature of each light source is configured to be detectable by installing a temperature sensor near each light source.

The controller 170 controls, as the first step, relevant components so as to make transitions of the first detection unit 150, the light modulator 60, and the cooling unit 35 to off states, and so as to make a transition of only the light source 10 in which a failure has occurred to an off state (S146). The image to be set in the light modulator 60 by the image signal setting unit 55 may be a black image or the image displayed at the detection of the entering object. The controller 170 controls, as the second step, relevant components so as to sequentially make transitions of the plurality of light sources 10 in which a failure has not occurred to off states (S147), and finally all of the light sources 10 are made transitions to off states (S148). Thereby, a rapid change in the temperature near the light source unit 12 can be suppressed.

As stated above, according to the embodiment, appropriate and efficient safety measures can be implemented by initiating the safety processing, different between the case where an entering object has been detected and the case where an error has occurred in the projection display 100 itself. For example, when an entering object has been detected, the state in which the projection display can be easily restored while ensuring the security of the entering object, can be maintained by initiating the safety processing of merely switching to the projection of a black image.

The present invention has been described above based on some embodiments. These embodiments are intended solely for the purpose of illustration, and it should be understood by those skilled in the art that various modifications are possible in combining those various components and various processing and those modifications also fall in the scope of the present invention.

For example, in the second example of the aforementioned safety processing for detecting an entering object (S16), the number of the light sources, the operations of which are to be stopped, may be determined in accordance with the position where the entering object in the detection area 300 has been detected. That is, when an entering object has been detected, the controller 170 controls relevant component so as to stop the operation of at least one light source and so as to maintain the state of the projection display 100, excluding the aforementioned stop of the operation. In this case, the controller 170 determines the number of the light sources, the operations of which are to be stopped, in accordance with the distance between the detected entering object and the projection space 350. As the distance is smaller, operations of more light sources are stopped. The correspondence relationship between the distance and the number of the light sources may be written and held in a table in advance. Alternatively, the number of the light sources may be determined by multiplying the distance by a predetermined proportional constant.

The distance between the detected entering object and the projection space 350 can be estimated by applying an existing image analysis technology to the captured images supplied from the first camera 150a and the second camera 150b. According to this variation, further optimized safety measures can be implemented.

In addition, in the second example of the aforementioned safety processing for detecting an entering object (S16), the position of the light sources, the operations of which are to be stopped, may be determined in accordance with the position where the entering object in the detection area 300 has been detected. That is, when an entering object has been detected, the controller 170 controls relevant components so as to stop the operation of the light source, emitting a light toward the direction where the entering object is present, and so as to maintain the state of the projection display 100, excluding the aforementioned stop of the operation. According to this variation, further optimized safety measures can be implemented.

What is claimed is:

1. A projection display apparatus for projecting an image on a projection plane, the projection display apparatus comprising:
a detection unit configured to detect an entering object that will enter at least a projection space; and
a controller configured to initiate safety processing when an entering object is detected by the detection unit, the safety processing being milder than safety processing that is initiated when an error has occurred in the projection display apparatus itself.

2. The projection display apparatus according to claim 1, wherein, when the entering object has been detected, the controller controls components of the projection display apparatus so as to switch to the projection of a black image and so as to maintain the state of the projection display apparatus, excluding the switching.

3. The projection display apparatus according to claim 1, wherein, when the entering object has been detected, the controller controls components of the projection display apparatus so as to stop the operation of a light source and so as to maintain the state of the projection display apparatus, excluding the stop.

4. The projection display apparatus according to claim 1 further comprising a plurality of light sources, wherein, when the entering object has been detected, the controller controls components of the projection display apparatus so as to stop the operations of the plurality of light sources in a stepwise manner and so as to maintain the state of the projection display apparatus, excluding the stop.

5. The projection display apparatus according to claim 1 further comprising a plurality of light sources, wherein, when the entering object has been detected, the controller controls components of the projection display apparatus so as to stop the operation of at least one light source and so as to maintain the state of the projection display apparatus, excluding the stop, and wherein the controller determines the number of the light sources, the operations of which are to be stopped, in accordance with the distance between the detected entering object and the projection space.
